(19) United States
(12) Patent Application Publication
(10) Pub. No.: US 2023/0391156 A1
(43) Pub. Date: Dec. 7, 2023

(54) SPRING DEVICE

(71) Applicant: Rheinmetall Invent GmbH, Neuss (DE)

(72) Inventors: Ingo Goutier, Bad Rappenau (DE); Martin Weissert, Nordheim (DE); Jan Foerster, Neckarsuim (DE); Dennis Blank, Neckarsuim (DE)

(73) Assignee: Rheinmetall Invent GmbH, Neuss (DE)

(21) Appl. No.: 18/032,964

(22) PCT Filed: Oct. 22, 2021
(86) PCT No.: PCT/EP2021/079406

§ 371 Date: Apr. 20, 2023

(30) Foreign Application Priority Data
Oct. 22, 2020 (DE) 10 2020 127 866.7

(51) Int. Cl. B60G 17/015

(52) U.S. Cl. CPC B60G 17/015; B60G 2500/22; B60G 2202/11; B60G 2202/12; B60G 2202/13

(57) ABSTRACT

A spring device (1A, 1B) for a motor vehicle (2), comprising a spring unit (3) and a stiffness adjusting unit (15) configured to stiffen the spring unit (3) so as to dynamically vary the spring constant (k, k′) of the spring device (1A, 1B).

### CROSS-REFERENCE TO RELATED APPLICATIONS

This application is for entry into the U.S. National Phase from which priority is claimed under all applicable sections of Title 35 of the United States Code including, but not limited to, Sections 120, 363, and 365(c) to International Application Serial No. PCT/EP2021/079406, filed on Oct. 22, 2021 and entitled “SPRING DEVICE,” which in turn claims priority to German Patent Application Serial No. DE 10 2020 127 866.7, filed on Oct. 22, 2020 and entitled “FEDERVORRICHTUNG.” Each of International Application Serial No. PCT/EP2021/079406 and German application Serial No. DE 10 2020 127 866.7 is incorporated by reference herein in its entirety.

### FIELD OF THE INVENTION

The present invention relates to a spring device for a motor vehicle.

### BACKGROUND

In motor vehicles, springs may be provided in the chassis for spring mounting of the motor vehicle. With regard to driving comfort, the softest possible suspension is desirable. With regard to driving dynamics, on the other hand, a hard suspension is advantageous. There are thus mutually contradictory requirements, the advantages and disadvantages of which, however, depend on the driving situation or on the vehicle condition, in particular on a load of the motor vehicle. There is thus no permanently optimum suspension setting for the motor vehicle. In the case of passive springs, the design of the spring is therefore always a compromise between the different requirements on the spring properties depending on the situation.

While a soft suspension generally serves the purpose of comfort, it can, however, lead to a strong load on the outer radius side during cornering, for example, and thus to a rolling motion of the motor vehicle exactly contrary to the driver's perception of comfort. Air springs are partially active, i.e. they can change their spring constant, but they are too sluggish for a dynamic change of the spring constant. It is therefore desirable to have a spring constant setting that can be dynamically adapted to the situation.

The applicant is aware of in-house prior art in which this can be achieved in part by progressive suspension. Such a suspension, for example an air spring, has an increasing spring effect with increasing deflection or with in-creasing load on the suspension. In other words, the suspension can be soft when the road surface is slightly uneven and hard when the road surface is very uneven. However, no active adaptation to the driving situation or the situational requirements is possible.

Furthermore, according to the in-house state of the art, it is possible to use an active suspension. In this case, an active counter-movement to the compression is generated, usually by an active damper movement. However, this is a complex system that is expensive, heavy, energy-intensive and has limited responsiveness.

In a so-called semi-active suspension with a damper, an in-situ adjustment of the damper, i.e. the damping coefficient, is possible. The damper can therefore either stiffen to slow down or slow down the compression or extension process, or soften to allow the compression or extension process to take place quickly. Semi-active suspensions, however, are only dynamically effective, not statically. This means that compression cannot and must not be prevented, but only delayed.

When so-called roll stabilizers are used, they pull the motor vehicle straight when cornering by twisting a torsion spring, the torsional force of which counteracts this twisting. Here, active variants are also known to the applicant internally, which increase the pull. However, these are ineffective in the case of uniform deflection of the wheels of an axle.

Against this background, one object of the present invention is to provide an improved spring device.

### SUMMARY OF THE DISCLOSURE

Accordingly, a spring device for a motor vehicle is proposed. The spring device comprises a spring unit and a stiffness adjusting unit configured to stiffen the spring unit so as to dynamically change the spring constant of the spring device.

By providing the stiffness adjusting unit, it is possible to actively adjust the spring constant of the spring device during operation of the spring device to the respective driving situation of the motor vehicle or to its load condition. This is done situationally, i.e. highly dynamically and in real time. The spring constant can thus be changed in real time.

The motor vehicle may have any number of such spring devices. The spring unit may be, for example, a coil spring or a leaf spring. The spring unit may, for example, be made of a metallic material, in particular a spring steel, or of a composite material, such as a fiber composite plastic. Preferably, the spring unit is a compression spring. However, the spring unit may also be a tension spring.

Preferably, the spring unit is, or may be referred to as, a flexure spring or flexure spring unit. That is, the terms “spring unit” and “flexure spring unit” may be interchanged as desired. By a “flexure spring” or a “flexure spring unit” is meant in the present context a component, in the simplest case a rod-shaped flexure beam, which deforms spring-elastically and thus reversibly under load. The material properties of the material used and the geometry of the spring unit influence its deformation behavior. One example of a flexure spring is a leaf spring.

The spring unit may also be, or may be referred to as, a torsion spring or torsion spring unit. That is, the terms “spring unit” and “torsion spring unit” may also be interchanged as desired. An example of a torsion spring is a coil spring or cylindrical spring in which a spring wire is coiled in a helical shape. In the case of torsion springs, the material properties of the material used and the geometry of the spring unit also influence their deformation behavior. The spring unit may also be or be described as a flexure or torsion spring unit. In contrast to flexure springs or torsion springs, an air spring or gas spring utilizes the compressibility of air or a gas. The spring unit is therefore not an air spring or gas spring.

The spring device differs from the spring unit in that the spring device comprises both the spring unit and the stiffness adjusting unit. That is, the spring unit and the stiffness adjusting unit are part of the spring device. The stiffness adjusting unit, on the other hand, is not part of the spring unit. However, this does not preclude the stiffness adjusting unit from being attached or secured to the spring unit. The spring device may comprise a plurality of spring units.

The spring constant, spring stiffness, spring hardness or spring rate indicates the ratio of a force acting on the spring device to a deflection of the spring device caused thereby. In the present context, “stiffness” means the resistance of the spring unit to elastic deformation. In other words, the stiffness adjusting unit is suitable for influencing the spring unit in such a way that its resistance to elastic deformation is changed, in particular increased. The stiffening of the spring unit can thereby take place either locally or globally. “Local” in this case means only in certain sections of the spring unit. In contrast, “global” means that the entire spring unit is stiffened.

In the present case, “changing” means in particular that the spring constant can be continuously adjusted, in particular increased, with the aid of the stiffness adjusting unit. However, the spring constant can also be reduced. This changing or adjusting of the spring constant is reversible. The stiffness adjusting unit can also be referred to as a spring stiffness adjusting unit or a spring constant adjusting unit.

The fact that the spring constant is or can be changed “dynamically” means in the present case in particular that the change takes place in real time, that is to say without any time delay, and in particular during the operation of the spring device, for example during a deflection of the spring unit, and in particular also under a loading or stress of the spring device. The change thus takes place almost instantaneously or without delay.

According to one embodiment, the spring unit is made of a fiber reinforced plastic.

The fiber reinforced plastic (FRP) may also be referred to as fiber reinforced plastic material. The fiber reinforced plastic comprises a plastic material, in particular a plastic matrix, in which fibers, for example natural fibers, glass fibers, carbon fibers, aramid fibers or the like, are embedded. The plastic material may be a thermoset, such as an epoxy resin. However, the plastic material may also be a thermoplastic. The fibers may be continuous fibers. However, the fibers may also be short or medium length fibers, which may have a fiber length of a few millimeters to a few centimeters. The fibers may be arranged directionally or non-directionally in the plastic material. The spring unit may have a layered or stratified structure. For this purpose, layers of fiber fabric or fiber scrim are impregnated with the plastic material, for example. Alternatively, however, so-called prepregs, i.e. pre-impregnated fibers, fiber fabrics or fiber scrims, can be used to manufacture the spring unit. Alternatively, however, the spring unit may be made of a metallic material, such as a stainless steel.

According to a further embodiment, the spring unit is a leaf spring unit. That is, the terms “spring unit” and “leaf spring unit” may be interchanged as desired. Alternatively, however, the spring unit may be a coil spring. In contrast to the leaf spring unit, a cylindrical spring or coil spring has a continuous wire which is helically shaped such that the coil spring has a cylindrical geometry. In the case where the spring unit is a leaf spring unit, the spring unit may have a zigzag or meander shaped structure. In the case where the spring unit is a leaf spring unit, the spring device is or may be referred to as a leaf spring device. That is, the terms “spring device” and “leaf spring device” may also be interchanged as desired.

According to a further embodiment, the spring unit comprises a plurality of leaf spring sections and a plurality of deflection sections, and in each case one deflection section connecting two adjacent leaf spring sections to one another.

That is, the leaf spring sections and the deflection sections are arranged alternately. This results in the zigzag or meandering structure of the spring unit. The individual leaf spring sections may have a leaf-shaped or plate-shaped geometry. “Leaf-shaped” or “plate-shaped” does not, however, preclude the leaf spring sections from being curved or shaped in any three-dimensional manner. The leaf spring sections may be integrally connected to one another by means of the deflection sections, in particular integrally made of one material. “Integrally” or “one-piece” means in the present case that the leaf spring sections and the deflection sections form a common component and are not composed of different components. “Integrally made of one material” means, in particular, in the present case that the leaf spring sections and the deflection sections are manufactured from the same material throughout. Preferably, the deflection sections have a larger cross-sectional area than the leaf spring sections. This results in a greater stiffness of the deflection sections compared to the leaf spring sections. This ensures that, when the spring unit compresses, it is essentially the leaf spring sections and not the deflection sections that deform in a spring-elastic manner. The deflection sections thus form deactivated zones of the spring unit, or may be designated as such. Alternatively, the leaf spring sections may be interconnected by means of sleeve-shaped or clamp-shaped deflection sections. In this case, the spring unit is neither integrally formed nor integrally made of one material.

According to another embodiment, the leaf spring sections comprise an S-shaped geometry.

In particular, the leaf spring sections have the S-shaped geometry or shape in cross-section. After a compression of the spring unit, the leaf spring sections preferably have a flat geometry.

According to a further embodiment, the stiffness adjusting unit comprises a stiffening element for stiffening the spring unit, which is attached to the spring unit.

The stiffening element may also be referred to as or be an insert. For example, the stiffening element may be inserted into the spring unit. The stiffening element may also be fixedly connected to the spring unit. For example, the stiffening element is materially bonded to the spring unit. In materially bonded connections, the connecting partners are held together by atomic or molecular forces. Materially bonded connections are non-detachable connections that can only be separated from each other by destroying the connecting means and/or the connecting partners. Materially bonded connections can be made, for example, by adhesive bonding or vulcanization.

According to a further embodiment, the stiffening element is cylindrical.

For example, the stiffening element can be glued or inserted into one of the deflection sections. However, the stiffening element may also be inserted into a coil of a coil spring. The stiffness adjusting device may have any number of stiffening elements. In this regard, each deflection section or certain deflection sections may be associated with its own stiffening element. The geometry of the stiffening element is arbitrary. For example, the stiffening element is circular cylindrical in cross-section. However, the stiffening element can also be polygonal in cross-section, in particular rectangular, oval or star-shaped.

According to a further embodiment, the stiffening element encloses the spring unit at least in sections.

That is, the spring unit is at least partially arranged within the stiffening element. In particular, the spring unit is at least partially surrounded or enclosed by material of the stiffening element. For example, the stiffening element is cast onto the spring unit. By the stiffening element enclosing the spring unit, the stiffening element additionally protects the spring unit from environmental influences, such as water, ice, dirt or UV radiation. This increases the service life of the spring device.

According to another embodiment, the spring unit comprises a soft spring section with a first spring constant and a hard spring section with a second spring constant, wherein the second spring constant is greater than the first spring constant, and wherein the stiffening element is attached only to the soft spring section.

In this case, the spring unit is a progressive spring unit. This means that the spring constant of the spring unit has a progressive and not a linear course. Due to the fact that the stiffening element is only provided at the soft spring section, it is possible to specifically influence only the soft spring section. Alternatively, however, a stiffening element may also be provided additionally on the hard spring section. The soft spring section may also be referred to as the first spring section. The hard spring section may also be referred to as the second spring section.

According to a further embodiment, the stiffening element is adapted to deactivate the soft spring section.

In the present case, “deactivating” means that the stiffening element prevents the soft spring section from compressing. The soft spring section is thus blocked or frozen. That is, the spring action of the spring device is achieved substantially exclusively by means of the hard spring section.

According to a further embodiment, the stiffness adjusting unit comprises a control apparatus for actuating the stiffening element, wherein the stiffening element can be brought from a deactivated state to an activated state and vice versa by means of the control apparatus, and wherein the spring constant of the spring unit in the activated state is greater than in the deactivated state.

This means, for example, that the stiffening element has a higher stiffness or modulus of elasticity in the activated state than in the deactivated state. The control apparatus may comprise, for example, an electric circuit with a voltage source and/or an electric coil. “Driving” the stiffening element comprises, for example, energizing the same by means of the voltage source and the electric circuit. However, “driving” may also comprise applying an electric field or a magnetic field to the stiffening element.

According to a further embodiment, an arbitrary number of intermediate states is provided between the deactivated state and the activated state, so that the spring constant of the spring unit can be varied continuously.

Bringing the stiffening element from the deactivated state to the activated state is reversible. For example, the stiffening element may be brought from the activated state back to the deactivated state in which the aforementioned voltage source is turned off. For example, the higher the voltage applied to the stiffening element, the greater the spring constant of the spring device.

According to a further embodiment, the stiffening element can be brought from the deactivated state into the activated state by means of a current applied to it, by means of an electric field and/or by means of a magnetic field.

Conversely, the stiffening element can also always be in the activated state as the initial state. In this case, the stiffening element is brought from the activated state to the deactivated state with the aid of the control apparatus. In the present context, “energizing” means in particular that a voltage is applied to the stiffening element by means of the electric circuit and the voltage source. Preferably, the electric field or the magnetic field is generated by means of an electric coil of the stiffness adjusting unit. In the latter case, the stiffening element can be controlled in particular without contact. This results in a less complex structure, since no wiring of the stiffening element is required.

According to a further embodiment, when the stiffening element is brought from the deactivated state into the activated state, properties, in particular material properties and/or geometric properties, of the stiffening element change in such a way that the spring constant of the spring device increases.

In particular, the properties of the stiffening element change in such a way that it impedes deformation of the spring unit, thus increasing its stiffness locally or globally. This increases the spring constant of the spring device. The material properties may comprise, for example, hardness, modulus of elasticity or the like. The geometric properties may comprise, for example, dimensions of the stiffening element, such as its diameter, its width, its thickness or the like.

Further, the geometric properties may comprise the shape of the stiffening element. For example, the stiffening element has a circular cross-section in the deactivated state and an elliptical cross-section in the activated state.

According to a further embodiment, the stiffening element comprises a magnetorheological material and/or an electrorheological material.

Preferably, the stiffening element comprises a magnetorheological elastomer and/or an electrorheological elastomer. The stiffening element may be made of individual materials or of a combination of different materials which, for example, only partially change their properties within the electric or magnetic field. Magnetorheological elastomers comprise an elastomer matrix and magnetically active particles dispersed therein. In such magnetorheological elastomers, the viscoelastic or dynamic mechanical properties can be rapidly and reversibly changed by applying an external magnetic field. The stiffening element may also comprise an electrorheological fluid, elastomer or the like.

“One” as used herein is not necessarily to be understood as being limited to exactly one element. Rather, multiple elements, such as two, three or more, may also be provided. Also, any other counting word used herein is not to be understood as limiting the number of elements to exactly that number. Rather, numerical variations upward and downward are possible unless otherwise indicated.

Further possible implementations of the leaf spring device also comprise combinations, not explicitly mentioned, of features or embodiments described before or below with respect to the embodiments. In this regard, the skilled person will also add individual aspects as improvements or additions to the respective basic form of the leaf spring device.

Further advantageous embodiments and aspects of the leaf spring device are the subject of the subclaims, as well as the embodiments of the leaf spring device described below. Further, the leaf spring device will be explained in more detail by means of preferred embodiments with reference to the accompanying figures.

### BRIEF DESCRIPTION OF THE DRAWINGS

FIG. 1 shows a schematic view of an embodiment of a spring device;

FIG. 2 shows a further schematic view of the spring device according to FIG. 1;

FIG. 3 shows the detailed view III according to FIG. 1;

FIG. 4 schematically shows a force-deflection curve of the spring device according to FIG. 1;

FIG. 5 again shows the detailed view III according to FIG. 1;

FIG. 6 schematically shows a further force-deflection curve of the spring device according to FIG. 1;

FIG. 7 shows a schematic view of a further embodiment of a spring device;

FIG. 8 schematically shows a force-deflection curve of the spring device according to FIG. 7;

FIG. 9 shows a further schematic view of the spring device according to FIG. 7; and

FIG. 10 schematically shows a further force-deflection curve of the spring device according to FIG. 7.

In the figures, identical or functionally identical elements have been provided with the same reference signs, unless otherwise indicated.

### DETAILED DESCRIPTION

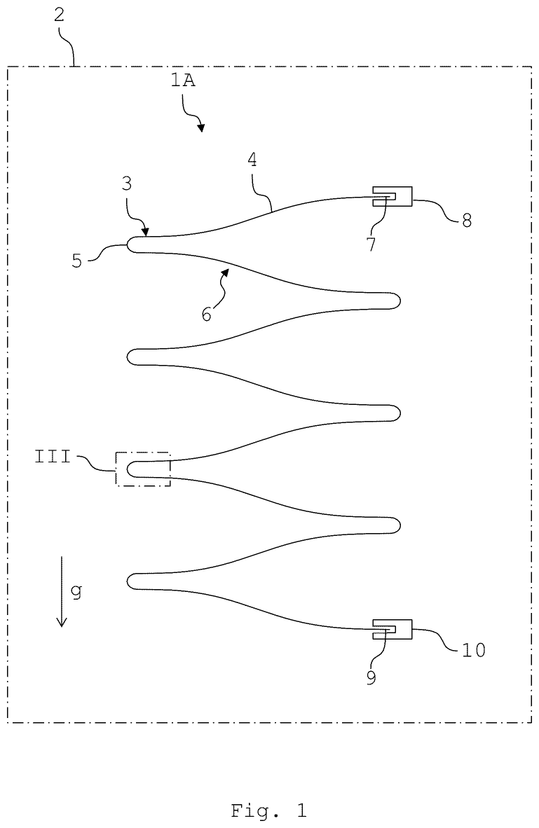

FIG. 1 shows a schematic view of a spring device 1A. The spring device 1A is, or may be described as, a leaf spring device. However, the spring device 1A may be any embodiment of a spring, for example a coil spring or the like. However, hereinafter it will be understood that the spring device 1A is a leaf spring device. The spring device 1A is suitable for use in or on a motor vehicle 2, in particular on a wheeled vehicle. The spring device 1A may find application in the region of a wheel suspension of the motor vehicle 2. The motor vehicle 2 may comprise any number of spring devices 1A.

The spring device 1A comprises a spring unit 3. The spring unit 3 is, or may be described as, a leaf spring unit. However, the spring unit 3 may also be a coil spring, for example. The spring unit 3 is made of a fiber-reinforced plastic material or a fiber reinforced plastic (FRP). Alternatively, however, the spring unit 3 may also be at least partially made of a metallic material, for example spring steel. In the following, however, it will be assumed that the spring unit 3 is made of a fiber-reinforced plastic material.

The fiber composite plastic comprises a plastic material, in particular a plastic matrix, in which fibers, for example natural fibers, glass fibers, carbon fibers, aramid fibers or the like, are embedded. The plastic material may be a thermoset, such as an epoxy resin. However, the plastic material may also be a thermoplastic. The fibers may be continuous fibers. However, the fibers may also be short or medium length fibers, which may have a fiber length of a few millimeters to a few centimeters. The spring unit 3 may have a layered or stratified structure. For this purpose, layers of fiber fabric or fiber scrim are impregnated with the plastic matrix, for example. Alternatively, however, so-called prepregs, i.e. pre-impregnated fibers, fiber fabrics or fiber webs, can also be used to manufacture the spring unit 3.

The spring unit 3 has a meandering geometry. The spring unit 3 has a plurality of leaf spring sections 4 which are connected to each other at deflection sections 5. The number of leaf spring sections 4 is arbitrary. In FIG. 1, a leaf spring section 4 and a deflection section 5 are each provided with a reference sign. The individual leaf spring sections 4 each have an S-shaped geometry or have an S-shaped course in the side view.

The leaf spring sections 4 can be connected to each other integrally, in particular integrally made of one material, by means of the deflection sections 5. “Integrally” or “one-piece” means in the present case that the leaf spring sections 4 and the deflection sections 5 form a common component and are not composed of different components. “Integrally made of one material” means in particular that the leaf spring sections 4 and the deflection sections 5 are made of the same material throughout.

The leaf spring sections 4 and the deflection sections 5 are designed in such a way that, when the spring unit 3 is loaded, no deformation, or at least no appreciable deformation, takes place in the deflection sections 5. The leaf spring sections 4, on the other hand, are each deformed in a central region 6 and generate a spring force counteracting a load acting from the outside.

A first end section 7 of the spring unit 3 is supported in a first bearing unit 8. A second end section 9 of the spring unit 3 is accordingly supported in a second bearing unit 10. The first bearing unit 8 may, for example, be part of a frame of the motor vehicle 2. The second bearing unit 10 may be part of an axle guide of the motor vehicle 2. The bearing units 8, 10 are part of the spring device 1A. With respect to a direction of gravity g, the first bearing unit 8 is placed above the second bearing unit 10. The first bearing unit 8 is, or may be described as, a spring shoe. The second bearing unit 10 is also a spring shoe or may be referred to as such.

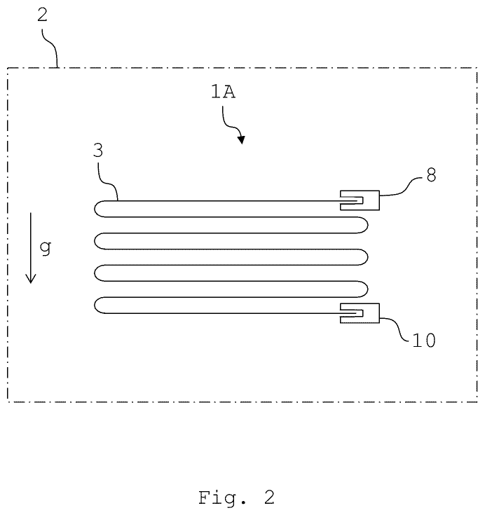

FIG. 1 shows the spring device 1A in an unloaded or deflected state. In contrast, FIG. 2 shows the spring device 1A in a loaded or compressed state. In the compressed state, the leaf spring sections 4, which are S-shaped in the unloaded state, have a planar shape.

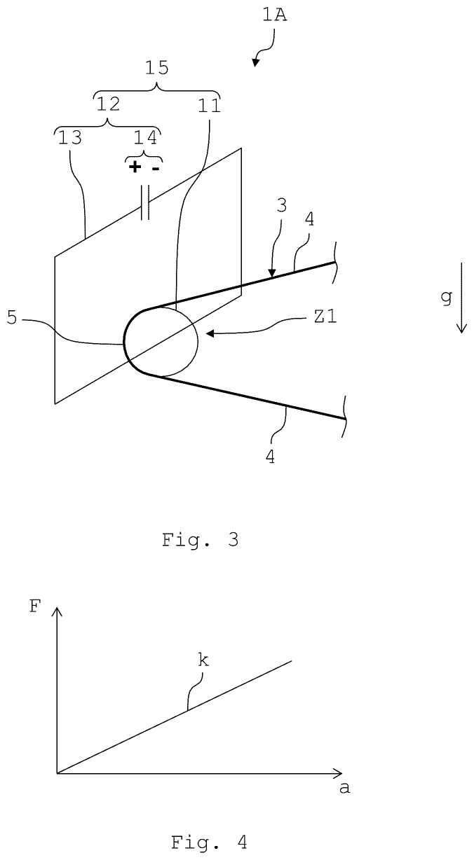

FIG. 3 shows the detailed view III according to FIG. 1. As previously mentioned, the spring unit 3 comprises leaf spring sections 4, two of which are shown in FIG. 3, which are connected to each other by means of a deflection section 5. However, FIG. 3 may also show a part of a coil of a helical spring, for example, in the case where the spring unit 3 is not a leaf spring unit. More generally, FIG. 3 shows a spring section or spring train with at least one coil.

The spring device 1A comprises a stiffening element 11 which makes it possible to influence the spring stiffness or spring constant k (FIG. 4) of the spring device 1A during operation of the motor vehicle 2 or of the spring device 1A, in other words to increase or decrease it as required. The “spring constant” or “spring stiffness” indicates the ratio of a force F (FIG. 4) acting on the spring device 1A to a deflection a (FIG. 4) of the spring device 1A caused thereby.

The stiffening element 11 may have any geometry. For example, the stiffening element 11 may be cylinder-shaped or roller-shaped. The stiffening element 11 may be provided, for example, on the deflection section 5. A plurality of stiffening elements 11 may be provided, and such a stiffening element 11 may be associated with each or only selected deflection sections 5.

The stiffening element 11 or the stiffening elements 11 can either be attached locally to one or individual sections of the spring unit 3, in particular to the deflection sections 5, or can also enclose the entire spring unit 3. The stiffening element 11 may be inserted or glued into the deflection section 5. In case the spring unit 3 is a coil spring, the stiffening element 11 may also be placed between coils of the spring unit 3.

With the aid of a control apparatus 12, the stiffening element 11 can be controlled in such a way that it specifically changes its properties in such a way that the spring constant k, the spring travel, the extension or the like of the spring device 1A are influenced. In other words, the properties of the spring device 1A are selectively influenced. This can be done locally, for example at only one of the deflection sections 5, or at the entire spring unit 3.

In order to influence the properties of the spring device 1A, a signal, in particular an electrical signal, is applied to the stiffening element 11, for example. In the event that several stiffening elements 11 are provided, these can be controlled individually or jointly. In this context, the “properties” of the stiffening element 11 may be understood, for example, as its geometric extension, for example a diameter, a length, a thickness, a width or the like, or its geometric shape, for example circular, oval or polygonal.

However, the “properties” of the stiffening element 11 may also be understood to mean material properties such as, for example, hardness, viscosity, stiffness, modulus of elasticity or the like. The control apparatus 12 may also be used to influence any combination of the aforementioned properties of the stiffening element 11. For example, the stiffening element 11 can be controlled by means of the control apparatus 12 in such a way that the stiffening element 11 stiffens and/or deforms at least locally.

In particular, the stiffening element 11 exhibits electrorheological or magnetorheological properties. In other words, the aforementioned properties of the stiffening element 11 that modify the spring constant k of the spring device 1A can be influenced by the application of an electric or magnetic field or by a direct energization of the stiffening element 11, respectively.

The stiffening element 11 may be made of individual materials or of a combination of different materials which, for example, only partially change their properties within an electric or magnetic field. The stiffening element 11 is made of an elastomer or of a composite material comprising an elastomer. For example, the stiffening element 11 may be made of a magnetorheological elastomer or comprise a magnetorheological elastomer.

Magnetorheological elastomers comprise an elastomer matrix and magnetically active particles dispersed therein. In such magnetorheological elastomers, the viscoelastic or dynamic mechanical properties can be rapidly and reversibly changed by applying an external magnetic field. The stiffening element 11 may also comprise an electrorheological fluid, elastomer or the like.

In the simplest case, the control apparatus 12 is an electric circuit 13 with a voltage source 14. The control apparatus 12 and the stiffening element 11 together form a stiffness adjusting unit 15 of the spring device 1A. The stiffening element 11 is part of the electric circuit 13. For example, in the view of FIG. 3, the voltage source 14 does not supply any voltage and the stiffening element 11 is in a deactivated state Z1.

In the deactivated state Z1, the stiffening element 11 is, for example, many times less stiff than the spring unit 3, so that deformation of the spring unit 3 by the stiffening element 11 is not hindered. The result is the curve of the spring constant k of the spring device 1A shown in FIG. 4. This curve of the spring constant k according to FIG. 4 essentially corresponds to the curve of a spring device not shown without such a stiffness adjusting unit 15.

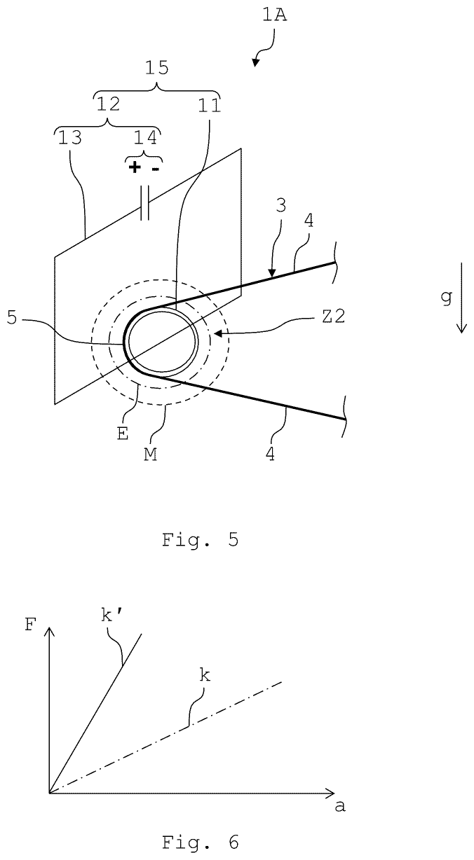

When a voltage is applied to the stiffening element 11, as shown in FIG. 5, the stiffening element 11 is moved from the deactivated state Z1 to an activated state Z2. The states Z1, Z2 are shown with different hatchings in FIGS. 3 and 5. For example, the stiffening element 11 has a different geometry in the activated state Z2 than in the deactivated state Z1. Further, the modulus of elasticity of the stiffening element 11 may change when the same is moved from the deactivated state Z1 to the activated state Z2.

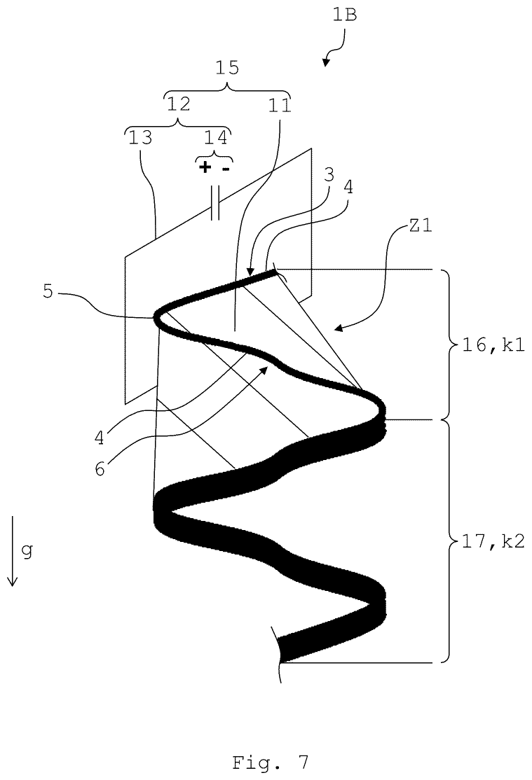

To stay with the previous example, in the activated state Z2 the stiffening element 11 may be many times stiffer than the spring unit 3, so that in the activated state Z2 the stiffening element 11 impedes the deformation of the spring unit 3 in such a way that, as shown in FIG. 6, compared to the deactivated state Z1, a steeper curve of the spring constant k′ of the spring device 1A results. That is, a smaller deflection a of the spring device 1A can be obtained with the same force F. The spring device 1A is therefore harder in the activated state Z2 than in the deactivated state Z1.

In this case, the stiffness adjusting unit 15 can be designed in such a way that the course of the spring constant k′ becomes increasingly steeper the higher the tension applied to the stiffening element 11. The spring constant k can thus be varied continuously. An infinite number of intermediate states can be provided between the deactivated state Z1 and the activated state Z2.

However, the control apparatus 12 may also be adapted to generate an electric field E or a magnetic field M for driving the stiffening element 11. In the activated state Z2, the stiffening element 11 is arranged, at least in sections, within the electric field E or the magnetic field M. It is thus possible to control the stiffening element 11 in a contactless or non-contacting manner. For generating the fields E, M, the control apparatus 12 may comprise a coil which can be energized. The coil may enclose the stiffening element 11 at least in sections. However, this is not mandatory.

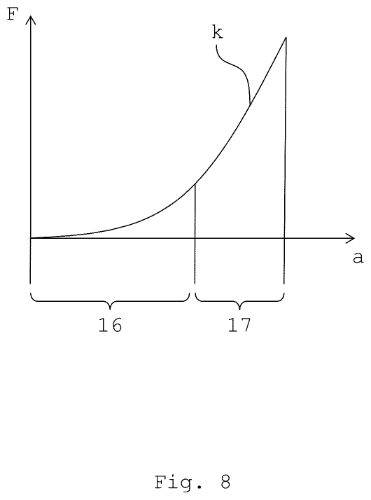

FIG. 7 shows a schematic view of a further embodiment of a spring device 1B, which is also suitable for the motor vehicle 2. In the following, only differences between the spring devices 1A, 1B will be discussed. The spring device 1B comprises a spring unit 3, which is a leaf spring unit as previously explained with leaf spring sections 4 and deflection sections 5 arranged between the leaf spring sections 4. The deformation of the leaf spring sections 4 takes place substantially in regions 6. The spring unit 3 is made of a fiber composite plastic.

In contrast to the spring device 1A, the spring device 1B comprises a spring unit 3 with a progressive characteristic curve. For this purpose, the spring unit 3 comprises a first or soft spring section 16 with a first spring constant k1 and a second or hard spring section 17 with a second spring constant k2. The second spring constant k2 is greater than the first spring constant k1. This difference in spring constants k1, k2 may be achieved, for example, by the hard spring section 17 having a larger cross-sectional area and/or a different geometry than the soft spring section 16. With respect to the direction of gravity g, the soft spring section 16 is placed above the hard spring section 17. The spring sections 16, 17 are connected to each other integrally, in particular integrally made of one material.

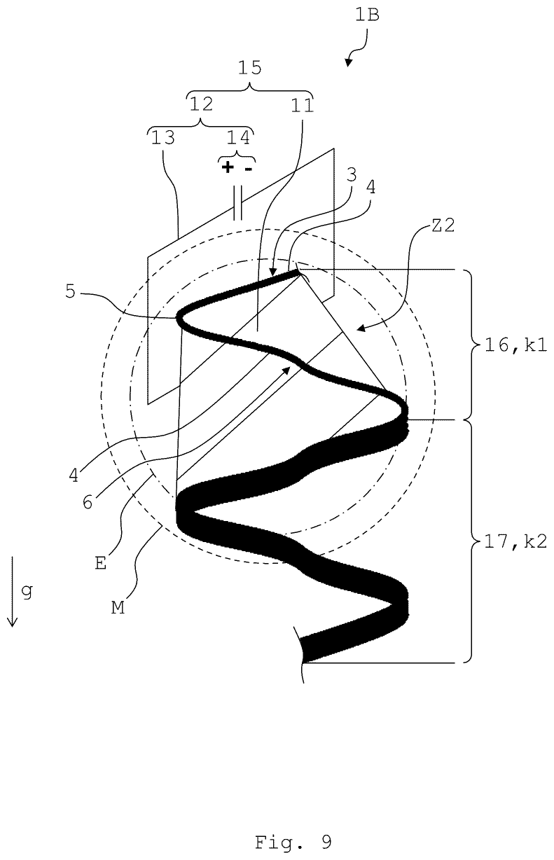

When a load is applied to the spring device 1B, the soft spring section 16 now flexes in first. The hard spring section 17 only compresses when the soft spring section 16 is almost or almost completely compressed. As shown in FIG. 8, this results in a progressive course of the spring constant k of the spring device 1B.

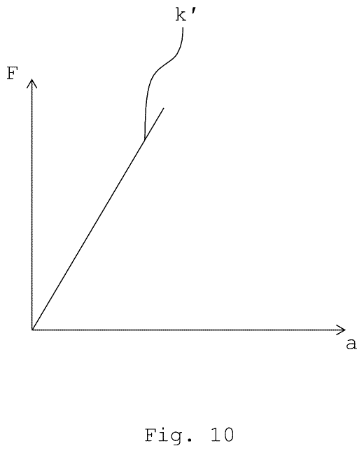

The spring device 1B comprises a stiffness adjusting unit 15 as previously mentioned, including a control apparatus 12 and a stiffening element 11. The stiffening element 11 is preferably provided at the soft spring section 16. Thereby, as explained with reference to FIGS. 3 and 5, the stiffening element 11 may be provided only at the deflection section 5 or only at the deflection sections 5. However, the stiffening element 11 may also envelop or wrap the entire soft spring section 16, as shown in FIGS. 7 and 9.

For example, the stiffening element 11 is materially bonded to the soft spring section 16. In the case of materially bonded connections, the connecting partners are held together by atomic or molecular forces. Materially bonded connections are non-detachable connections which can only be separated by destroying the connecting means and/or the connecting partners. Materially bonded joints can, for example, be joined by adhesive bonding or vulcanization. For example, the stiffening element 11 is molded to the soft spring section 16.

The stiffening element 11 has electrorheological or magnetorheological properties, as previously mentioned. By means of the control apparatus 12, the stiffening element 11 can be brought from a deactivated state Z1 (FIG. 7) to an activated state Z2 (FIG. 9) and vice versa. This can be done, for example, by energizing the stiffening element 11 or by applying an electric field E (FIG. 9) or a magnetic field M thereto. The different states Z1, Z2 are shown in FIGS. 7 and 9 with differently oriented hatchings.

In the activated state Z2, the stiffening element 11 deactivates the soft spring section 16 such that substantially only the hard spring section 17 compresses when the spring device 1B is loaded. The soft spring section 16 is frozen and ideally does not contribute anything to the spring action of the spring device 1B. As shown in FIG. 10, this results in a linear variation of the spring constant k′. The spring constant k′ then substantially corresponds to the second spring constant k2. In addition, stiffening elements 11 can also be provided on the hard spring section 17.

With the aid of the stiffness adjusting unit 15, it is thus possible to quickly change the spring constant k, for example, in order to actively adjust or control the spring deflection and the spring constant k of the spring device 1A, 1B in real time. It is possible to compensate for height, for example in the event of a change in load, and to shift the natural frequency of the spring device 1A, 1B into a non-critical range. A wheel-, side- and/or axle-specific change of the spring constant k can be carried out, for example during cornering, for roll stabilization, during acceleration, during braking and/or within the scope of electronic compensation systems or so-called body control systems.

With the help of the continuous change of the spring constant k, both ride comfort and driving dynamics can be improved. This can also be achieved without the use of a progressive suspension (not shown), whose spring constant is dependent on the spring deflection. By making the spring constant k adjustable, damper functions can be supported. The spring device 1A, 1B can at least partially replace other, partly active, chassis components, such as a roll stabilizer, dampers, air springs or the like, or at least a smaller dimensioning of these chassis components is possible within the scope of downsizing. It is possible to implement a highly dynamically switchable spring device 1A, 1B. Compared to active air springs, the spring device 1A, 1B is a simple, cost-effective and, in terms of dynamic usability, higher-performance solution.

Although the present invention has been described with reference to examples of embodiments, it can be modified in a variety of ways.

### LIST OF REFERENCE SIGNS

1A Spring device
1B Spring device
2 Motor vehicle
3 Spring unit
4 Leaf spring section
5 Deflection section
6 Region
7 End section
8 Bearing unit
9 End section
10 Bearing unit
11 Stiffening element
12 Control apparatus
13 Electric circuit
14 Voltage source
15 Stiffness adjusting unit
16 Spring section
17 Spring section
a Deflection
E Electric field
F Force
g Direction of gravity
k Spring constant
k′ Spring constant
k1 Spring constant
k2 Spring constant
M Magnetic field
Z1 State
Z2 State

1. Spring device for a motor vehicle, comprising:
a spring unit; and
a stiffness adjusting unit configured to stiffen the spring unit so as to dynamically vary the spring constant of the spring device.

2. Spring device according to claim 1, characterized in that the spring unit is made of a fiber reinforced plastic.

3. Spring device according to claim 1, characterized in that the spring unit is a leaf spring unit.

4. Spring device according to claim 3, characterized in that the spring unit comprises a plurality of leaf spring sections and a plurality of deflection sections, and in each case one deflection section connecting two adjacent leaf spring sections to one another.

5. Spring device according to claim 4, characterized in that the leaf spring sections comprise an S-shaped geometry.

6. Spring device according to claim 1, characterized in that the stiffness adjusting unit comprises a stiffening element for stiffening the spring unit, which is attached to the spring unit.

7. Spring device according to claim 6, characterized in that the stiffening element is cylindrical.

8. Spring device according to claim 6, characterized in that the stiffening element encloses the spring unit at least in sections.

9. Spring device according to claim 6, characterized in that the spring unit comprises a soft spring section with a first spring constant and a hard spring section with a second spring constant, wherein the second spring constant is greater than the first spring constant, and wherein the stiffening element is attached only to the soft spring section.

10. Spring device according to claim 9, characterized in that the stiffening element is adapted to deactivate the soft spring section.

11. Spring device according to claim 6, characterized in that the stiffness adjusting unit comprises a control apparatus for actuating the stiffening element, wherein the stiffening element can be brought from a deactivated state into an activated state and vice versa by means of the control apparatus, and wherein the spring constant of the spring device in the activated state is greater than in the deactivated state.

12. Spring device according to claim 11, characterized in that an arbitrary number of intermediate states is provided between the deactivated state and the activated state, so that the spring constant of the spring device can be varied continuously.

13. Spring device according to claim 11, characterized in that the stiffening element can be brought from the deactivated state into the activated state by means of a current applied to it, by means of an electric field and/or by means of a magnetic field.

14. Spring device according to claim 11, characterized in that when the stiffening element is brought from the deactivated state into the activated state, properties, in particular material properties and/or geometric properties, of the stiffening element change in such a way that the spring constant of the spring device increases.

15. Spring device according to claim 6, characterized in that the stiffening element comprises a magnetorheological material and/or an electrorheological material.
